(19) United States
(12) Patent Application Publication
(10) Pub. No.: US 2004/0068463 A1
(43) Pub. Date: Apr. 8, 2004

(54) Wireless quotation platform and method thereof

(76) Inventor: Jonathan C. Shih, Saratoga, CA (US)

Correspondence Address: BIRCH STEWART KOLASCH & BIRCH, PO BOX 747, FALLS CHURCH, VA, 22040-0747, US

(21) Appl. No.: 10/456,543

(22) Filed: Jun. 9, 2003

(30) Foreign Application Priority Data
Oct. 8, 2002 (TW) 91123165

(51) Int. Cl. G06F 17/60

(52) U.S. Cl. 705/37

(57) ABSTRACT

This invention proposes a wireless quotation platform and method employing Wireless Local Area Network (abbreviated as WLAN) for transmitting the quotation requirements from the client to the server (comprising a quotation service Web site and a quotation processing system) via WLAN connections, generating the quotation results and transmitting the results to operation terminals.

### BACKGROUND OF THE INVENTION

1. Field of the Invention

The invention is related to an automatic quotation system, especially to a system applied in the quotation processes of EMS (Electronics Manufacturing Services) receiving the client's quotation requirements via WLAN (Wireless Local Area Network) connections and dynamically generating the server's quotation results.

2. Related Art

Quotation is a very complicated problem that is hard to resolve effectively in the area of EMS. Due to various quotation requirements of customers and the high complexity of the EMS working model, manufacturers spend much manpower and time on processing various quotations of different customers, hence the efficiency of quotation processes is low. On the contrary, manufacturers can easily earn more if they have an efficient quotation mechanism to provide customers with the required quotation results immediately. As a result, an efficient quotation mechanism is crucial for EMS manufacturers and is necessary in the area of EMS.

In the past of the E-commerce era, building Web-based portal sites was widely used for establishing communication channels among customers and manufacturers to enable the manufacturers to know customers' quotation requirements and enable customers to find the required quotation results. However, in the M-commerce era where mobility is emphasized, when frequently facing the increasing competition, EMS manufacturers have started to feel the model used in the E-commerce era can no longer meet the timely needs. So how to employ WLAN software and hardware technologies to build a wireless quotation platform and method that is more flexible and can satisfy the customers' needs in quotation requirements in a more timely and more convenient manner than the computer-platform-limited E-commerce quotation mechanism, and to help EMS manufacturers earn more business opportunities, should be the important direction of effort from those EMS manufacturers with urgent desire to increase their competitiveness.

### SUMMARY OF THE INVENTION

The invention proposes a wireless quotation platform and method whose main objective is to provide EMS manufacturers with dynamic, space-unlimited, interactive, highly efficient and convenient quotation processes through the remote access between the client and server via WLAN software and hardware technologies.

To achieve the objective above, the proposed wireless quotation platform includes: the client's operation terminals, a server's quotation processing system and the server's quotation service Web site.

In addition, the proposed method includes the following steps. First, the connection between an operation terminal and a quotation service Web site is established. Then the operation terminal sends the quotation requirements to the quotation service Web site. After receiving the quotation requirements, the quotation service Web site sends the quotation requirements to the quotation processing system to purse the quotation requirements, extract the corresponding quotation results, generate the data pages of the quotation results and return the data pages to the quotation service Web site. The service Web site returns the data pages of the quotation results to the operation terminal, and finally, the connection between the operation terminal and the quotation service Web site is terminated.

Details of the invention are described below.

### BRIEF DESCRIPTION OF THE DRAWINGS

FIG. 1 shows the architecture of the proposed platform and method.

FIG. 2 shows the flowchart of the proposed platform and method.

FIG. 3 shows the detailed flowchart of the generation of the quotation requirements of the proposed platform and method.

FIG. 4 shows the detailed flowchart, generating the data pages of the quotation results as proposed.

### DETAILED DESCRIPTION

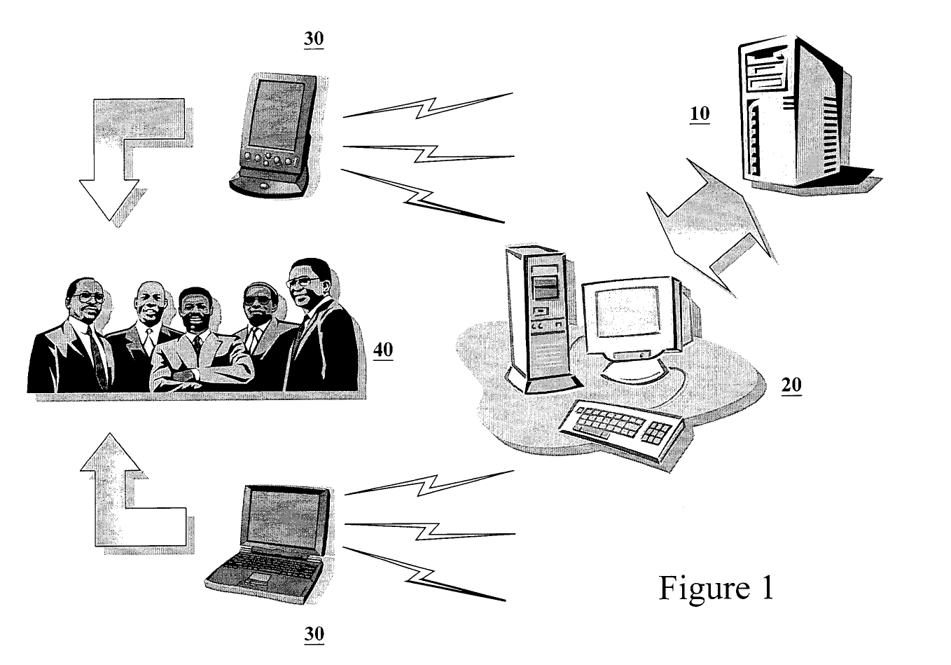

FIG. 1 shows the architecture of the proposed wireless quotation platform and method. The invention employs WLAN technologies (e.g., IEEE 802.11a, 802.11b, 802.11g . . . ) as communication media between the client's operation terminal 30 and the server's quotation service Web site 20. With wireless communication, a user can select and put in various quotation requirements, and transmit the quotation requirements to the server for processing the quotation, thus dynamically generating the quotation results to the user. The components are as follows.

1. A quotation processing system 10 at the server side receives and purses the quotation requirements from the quotation service Web site. While generating the quotation results, the quotation processing system 10 generates the data pages of the quotation results and sends the data pages to the quotation service Web site 20.

2. A server's quotation service Web site 20 connecting with an operation terminal 30 receives the quotation requirements from an operation terminal 30 put in by the user and sends the quotation requirements to the quotation processing system 10. When receiving the data pages of the quotation results for the quotation processing system 10, the quotation service Web site 20 returns the data pages to the operation terminal 30.

The quotation service Web site 20 provides a set of APIs (Application Program Interfaces) to the user in the operation terminal 30 for selecting and putting in the quotation requirements. The APIs are also used by the quotation service Web site 20 for sending the quotation requirements to the quotation processing system 10.

In addition, the quotation service Web site 20 contains a content database storing all quotation-related information. The user selects and browses the quotation-related information in the database by the operation terminal 30.

3. The operation terminal 30 at the client side provides the users with the operation, selection and input services (e.g., the selection and input of quotation requirements, the browsing of quotation-related information).

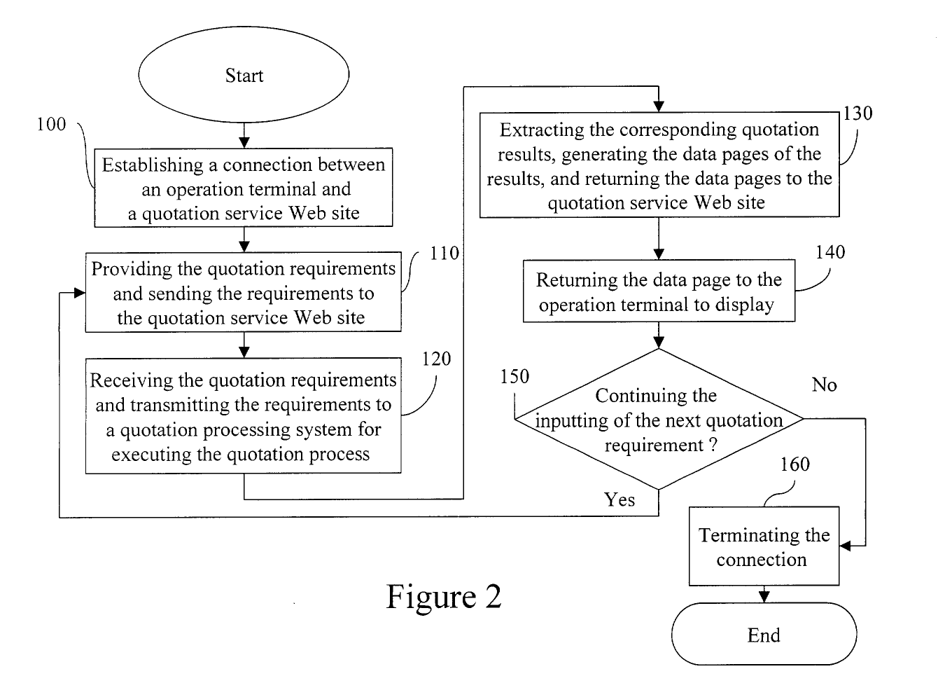

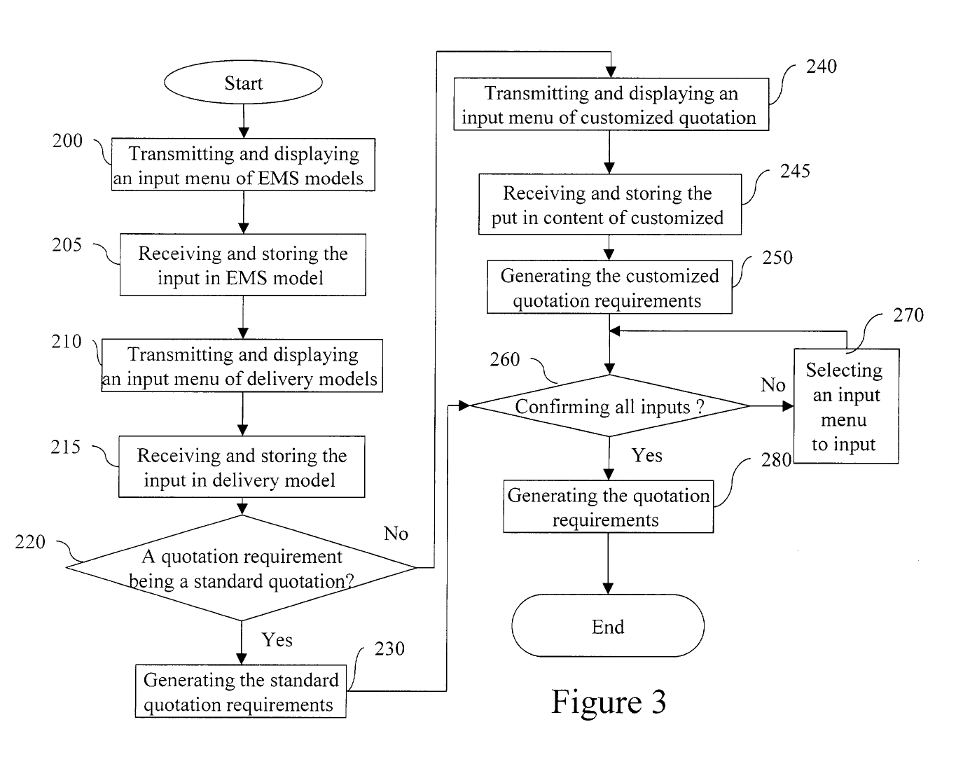

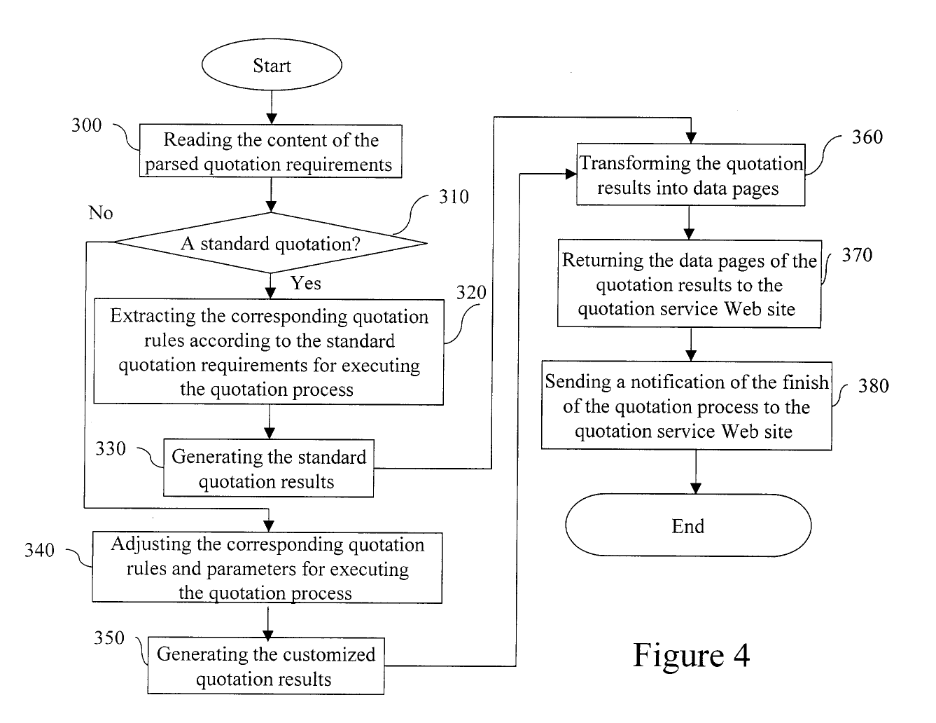

FIG. 2 shows the flowchart of the proposed platform and method. First, a connection between an operation terminal 30 and a quotation service Web site 20 is established (Step 100) by WLAN. After the connection is established, the user connects to the quotation service Web site 20 by the operation terminal 30 for selecting and putting in the quotation requirements, and sends the quotation requirements to the quotation service Web site 20 (Step 110). The generating-process for the quotation requirements is described in FIG. 3. Then, the quotation service Web site 20 sends the received quotation requirements to the quotation processing system 10 for pursing the requirements (Step 120) and determining what the content of the user's requirements is. After pursing, the quotation processing system 10 extracts the corresponding algorithm and quotation items from the database according to the users' quotation requirements and generates the quotation results. Then the quotation results are transformed to the data pages which is displayed in the operation terminal 30 and returned to the quotation service Web site 20 (Step 130). The generation of the data pages is described in FIG. 4. When receiving the data pages of the quotation results, the quotation service Web site 20 returns the data pages to the operation terminal 30 to display (Step 140). The quotation service Web site 20 determines whether the user wants to put the next quotation requirement in (Step 150). If so, the system enters Step 110. Otherwise, the connection between the operation terminal and the quotation service Web site is terminated (Step 160).

FIG. 3 shows the detailed flowchart of the generation of quotation requirements of the proposed platform and method, describing the detailed interaction between operation terminal 30 and quotation service Web site 30. Since practical quotation processes are quite complex, different combinations of quotation requirements generate different quotation results. However, the combinations of quotation requirements and the calculations of quotation are not in the scope of the invention, hence, we focus on the interaction between the operation terminal 30 and the quotation service Web site 20. First, when the user requires the quotations, the quotation service Web site 20 sends the input menu of EMS models to the user (Step 200), and receives and stores the user's input (Step 205). The quotation service Web site 20 sends the input menu of delivery models to the user (Step 210), and receives and stores the user's input (Step 215). If the user selects a standard quotation model (Step 220), the quotation service Web site 20 generates standard quotation requirements. Otherwise, if the user selects a customized quotation model (Step 220), the quotation service Web site 20 provides the input menu to the user for putting in special quotation requirements (Step 240), receives and stores the content of customized quotation (Step 245), and finally generates the customized quotation requirements (Step 250).

The quotation service Web site 20 then determines whether the user confirms all selected processes (Step 260). If so, the quotation service Web site integrates all standard or customized quotation requirements and generates the quotation requirements sent to the quotation processing system (Step 280). If the user does not confirm all selected processes (Step 260), the user can put in other quotation requirements (Step 270).

FIG. 4 shows the flowchart of generating the data pages of the quotation results. When receiving the quotation requirements from the quotation service Web site 20, the quotation processing system 10 first purses the received quotation requirements (Step 300) and determines whether the user selects a standard quotation (Step 310). If so, the quotation processing system extracts the default quotation rules and parameters according to the content of the standard quotation requirements for executing the quotation (Step 320) and generating the standard quotation results (Step 330). If the user selects a customized quotation, the quotation processing system adjusts the standard quotation rules and parameters according to the content of the customized quotation requirements executing the quotation (Step 340) and generating the customized quotation results (Step 350).

After generating the standard or customized quotation results, the quotation processing system 10 integrates the result to generate the data pages of the quotation results which can be browsed by the operation terminal 30 (Step 360) and returns the data pages to the quotation service Web site 20 (Step 370). In the meantime, the quotation processing system also sends a notice of the finish of the quotation processes to the quotation service Web site 20 (Step 380), and finally, the process is terminated.

Effects of the Invention

The proposed wireless quotation platform and method employing WLAN software and hardware technology eliminates the temporal and spatial limitations of quotation processes and increase the application area. Further, the quotation processes take less time.

The user immediately obtains the required quotation results. The proposed platform and method also increases the efficiency of the users' business.

The EMS manufacturers obtain and understand the customers' requirements, increase the customers' satisfaction through highly efficient quotation processes, and obtain more customers' orders, and generate more profit. While the preferred embodiment of the invention is made for disclosure, modifications of the disclosed embodiment of the invention as well as other embodiments thereof may occur to those skilled in the art. Accordingly, the appended claims are intended to cover all embodiments not departing from the spirit and scope of the invention.

What is claimed is:

1. A wireless quotation platform system which transmits the user-input quotation requirements from the client to the server to execute the quotation process to dynamically generate the quotation results via WLAN connections comprising:
an operation terminal at the client side which provides the selection and input of quotation requirements, the browsing of quotation-related information to the users;
a quotation processing system at the server side which receives and parses the quotation from the quotation service Web site to generate the data pages of the quotation results; and
a quotation service Web site at the server side which connects to an operation terminal and a quotation processing, sends the received quotation results to the quotation processing system, and returns the received data pages of the quotation results to the operation terminal.

2. The system in accordance with claim 1, wherein the quotation service Web site sends the quotation requirements to the quotation processing system via a set of APIs.

3. The system in accordance with claim 1, wherein the said quotation service Web site comprises a content database storing all quotation-related information which can be browsed by users via operation terminals.

4. A wireless quotation method which sends the user-inputted quotation requirements from the client to the server to execute the quotation process and generate the quotation results via WLAN connections comprising:
establishing a connection between an operation terminal and a quotation service Web site;
providing a quotation requirement to the said operation terminal and transmitting the requirement to the quotation service Web site;
receiving the quotation requirements and transmitting the requirements to a quotation processing system to parse the said requirements;
obtaining the quotation results, transforming the said results into data pages, and returning the data pages to the quotation service Web site; and
returning the data pages of the quotation results to the said operation terminal to display.

5. The method in accordance with claim 4, wherein the steps to provide a quotation requirement to the operation terminal and transmit the requirement to the quotation service Web site when the requirement is a standard quotation comprising:
transmitting and displaying an input menu of EMS models;
receiving and storing the put in EMS model;
transmitting and displaying an input menu of delivery models;
receiving and storing the put in delivery model;
generating a standard quotation requirement;
confirming the inputs; and
generating the quotation requirement.

6. The method in accordance with claim 4, which comprises the steps to enable the users to input next quotation requirement when the users do not confirm all inputs.

7. The method in accordance with claim 4, wherein when the said requirement is a customized quotation requirement, the generation of the said quotation requirement in the steps to provide a quotation requirement to the said operation terminal and transmit the said requirement to the quotation service Web site comprises:
transmitting and displaying an input menu of EMS models;
receiving and storing the put in EMS model;
transmitting and displaying an input menu of delivery models;
receiving and storing the put in delivery model;
transmitting and display an input menu of a customized quotation;
receiving and storing the content of the customized quotation;
generating a customized quotation requirement;
confirming the inputs; and
generating the quotation requirement.

8. The method in accordance with claim 7, which comprises the step to enable the users to input next quotation requirement when the users do not confirm all inputs.

9. The method in accordance with claim 4, wherein the generation of the data pages of standard quotation requirements in the steps to extract the quotation results, transform the said results into the data pages and return the data pages to the quotation service Web site comprises:
reading the content of the parsed quotation requirements;
extracting the corresponding quotation rules and parameters according to the standard quotation requirements to execute the quotation process;
generating the standard quotation results;
transforming the quotation results into data pages;
returning the data pages of the quotation results to the quotation service Web site; and
sending a notification of the finish of the quotation process to the quotation service Web site.

10. The method in accordance with claim 4, wherein the generation of the data pages of customized quotation requirements in the steps to extract the quotation results, transform the said results into the data pages and return the data pages to the quotation service Web site comprises:
reading the content of the parsed quotation requirements;
extracting and adjusting the corresponding quotation rules and parameters according to the customized quotation requirements to execute the quotation process;
generating the customized quotation results;
transforming the quotation results into data pages;
returning the data pages of the quotation results to the quotation service Web site; and
sending a notification of the finish of the quotation process to the quotation service Web site.
